(19) United States
(12) Patent Application Publication
(10) Pub. No.: US 2006/0178191 A1
(43) Pub. Date: Aug. 10, 2006

(54) Gaming apparatus and systems

(75) Inventor: Benjamin James Ellis, Wentworthville (AU)

Correspondence Address: INSKEEP INTELLECTUAL PROPERTY GROUP, INC, 2281 W. 190TH STREET, SUITE 200, TORRANCE, CA, 90504, US

(73) Assignee: Dynamite Games Pty Ltd.

(21) Appl. No.: 11/305,509

(22) Filed: Dec. 16, 2005

(30) Foreign Application Priority Data
Jun. 23, 2003 (AU) 2003903189
Jun. 23, 2004 (WO) PCT/AU04/00835

(51) Int. Cl. A63F 9/24; G06F 19/00; A63F 13/00; A63B 71/00

(52) U.S. Cl. 463/17; 273/143 R; 463/18; 463/20

(57) ABSTRACT

Gaming apparatus, e.g. an Electronic Gaming Machine (EGM) (1). Includes a controller (2) for implementing a roulette game. The controller (2) includes a display (5) on which is displayed a roulette wheel (9) and betting board (10), as well as a set of further roulette wheels (11) that can be bet on and played at the same time as betting on and playing the main wheel (9). The apparatus may also allow multi-wheel betting using a plurality of physical roulette wheels and an electronic terminal.

### CROSS-REFERENCE TO RELATED APPLICATIONS

This invention is related to and claims priority from Australian Patent Application No. 2003903189, filed Jun. 23, 2003; and PCT Application No. PCT/AU2004/000835, filed Jun. 23, 2004, entitled Gaming Apparatus And Systems, which are both incorporated herein by reference.

### FIELD OF THE INVENTION

The present invention relates to gaming apparatus and systems. It relates for example to electronic gaming machines and to networked gaming systems, such as Intranet and/or Internet-based gaming systems.

Gaming machines have been a popular form of entertainment for many years. This popularity has been enhanced by the advent of electronic gaming machines, and by computer-based gaming systems, such as are provided over the Internet.

Many different types of game are playable. They include for example standard slot-machine type games with spinning reels, poker machines, keno, bingo, blackjack, roulette, pachinko and the like.

A user will typically place a bet, press a button or pull a lever to begin a game, and will win or lose based upon the gaming machine's play algorithm and random number generator.

An aim of the present invention is to provide gaming apparatus having novel features for enhancing gameplay and increasing user participation.

### BACKGROUND

Viewed from one aspect, the present invention provides gaming apparatus including:
a plurality of roulette wheels;
input means for allowing a user to place a bet or bets on the plurality of roulette wheels during a round of betting;
means for determining the win statuses of the plurality of roulette wheels after a round of spins; and
means for displaying the bet outcome, the bet outcome being based on the input bet and on the win statuses of the roulette wheels.

The invention provides roulette wheel gaming apparatus in which a user may place a bet on and play more than one roulette wheel per round; and so may play a number of roulette wheels simultaneously, with e.g. a single bet being duplicated across all of the wheels.

The present invention provides a new approach to playing roulette that can add extra interest to the game over and above the usual game play. It benefits players by making the game more interesting, with for example wheels spinning simultaneously, ball drops taking place in rapid succession, and the possibility of a number of different win options. It also benefits the gaming operators by helping to increase use of their machines and spin rates.

The wheels themselves may be simulated wheels generated electronically e.g. with a random number generator determining a winning wheel slot, and with an animation for wheel spin and ball run and drop. In this case, the apparatus will include means for simulating a plurality of wheels and for displaying them upon a gaming screen of the apparatus.

Alternatively, or in combination with virtual wheels, the wheels may be real physical wheels that e.g. may be provided within a casino or the like. In this case, the apparatus may include a number of physical roulette wheels together with electronic betting facilities, e.g. a plurality of betting terminal that e.g. may be overseen by a central controller. In this case, the spin results from the tables may be input into the electronic betting facilities. This may be achieved automatically through electronic detection circuitry associated with the wheels, or by a croupier or the like entering the winning slots into a suitable input terminal.

The real roulette wheels may be provided as normal roulette tables or may be provided by themselves without the usual betting board, etc., as these can be provided by the electronic betting facilities. The wheels could be separate from one another or provided on the same table. They may be human-operated, e.g. by a croupier, or may be automated. They may comprise a bank of automated wheels linked to a set of user terminals, the wheels being spun together, e.g. simultaneously or in a set sequence.

The real roulette wheels may be located together, e.g. in a gambling pit, with a plurality of betting terminals adjacent to them, in which case the user of a terminal can see all of the wheels. The wheels may also be remote from the terminals, e.g. spread throughout a casino and/or even in another venue. In the former case, a terminal need not provide a representation of the wheels themselves on its screen, as they can be seen, although it may still be preferable to do so. In the latter case, as a user cannot see the real wheels that they are playing, the terminal will display the results of the wheel spins, and may for example display a plurality of virtual wheels that spin and stop in a manner reflecting the spins on the real wheels. In one embodiment, the apparatus may display video images of the wheels, e.g. overhead shots of the wheels, e.g. through the use of suitable camera apparatus. These images may be real time video sequences of the wheels or snap-shots of the wheels after the ball has dropped into a slot.

The wheels themselves may take any suitable form, and may be of any standard roulette format, including e.g. the US-style or 00 roulette and the Australian-style or 0 roulette (double and single zero roulette). The wheels may also include non-standard symbols/slots.

The number of wheels bet on per round may be fixed, e.g. at three, four or five wheels, or any other desired number, or may be variable. The number of wheels played may be selected by the user, and/or may be chosen automatically, e.g. based on the bet laid, and/or could be decided randomly.

The apparatus may allow a user to chose which of the wheels from a number of wheels they wish to play, e.g. to allow them to replace a wheel on which they lose or win by a new wheel. For example, if there are a number of physical wheels to chose from a user may chose specific ones to bet on.

Physical wheels may be locked out, e.g. when betting is finished on the table and the result is awaited, or when wins are being assessed and the like. When a table is locked out, the gaming apparatus will not place a user's bet on that table, but may still place a bet across the available tables. For example, a user may input one bet that is repeated or the like across all tables, and, before placing a second bet, one or more tables may become locked out. The second bet may then be placed on all of the remaining tables, so that the first bet is across all tables and the second bet is across a lesser number of tables.

The betting on the plurality of wheels may take any suitable form. An advantage of the present invention is that all of the wheels may be bet upon through a single roulette betting board, a bet on the board being repeated or otherwise allocated across the wheels.

In one preferred form, the same bet amount is replicated across the wheels. In another embodiment, bets are placed on the wheels according to a set formula, e.g. a first amount is placed on one wheel, and incrementally higher or lower amounts are placed on the other wheels. Bet allocation may also vary depending on the amount and type of a main bet. The bet allocation is preferably made automatically, without user input, although the latter is possible. The user may for example place the bets manually on the wheels, e.g. determine the amount and type of bet for each wheel independently.

The invention may in one aspect be seen as allowing a player to bet on a first main roulette wheel using the associated betting board, and automatically applying that bet to a number of further roulette wheels that can then all be played at the same time.

The bet type may take any of the usual forms associated with roulette. For example, a user may bet on a single (individual number), odd or even, red or black, high or low, a dozen, a row, a column, a line, a top line, a split, a triple, a corner or the like. The bet type is preferably repeated across the wheels, so that e.g. both the bet amount and bet type are repeated. It would also be possible however to vary the bet type between wheels, this again if applied being preferably automatic.

The win events that earn a user winnings may be the same as for standard roulette wheels, e.g. based on standard bet types, and will generally be separate wheel wins independent of each other. The present invention also however allows for additional win events based on mystery and bonus events, and allows win events to be based on the spin results for a number of the wheels played.

The wheels may be spun in any suitable manner. In one preferred embodiment, all of the wheels are spun together, and the wheels stop one after another. They could also however stop at the same time, and/or could start at different times. One wheel could start as another is finishing. The overlapping of the spins can increase user interest through the parallel running of wheels, as well as the bet rate. Stopping the wheels successively would allow a user to experience the anticipation of each “ball drop” into the slots individually. A number of “ball drops” one after the other in quick succession can provide an extra degree of excitement to the game play.

As well as standard roulette style functions, the gaming apparatus may be provided with bonus features relating to the use of multiple roulette wheels, e.g. a win event may be based on the results across a number of the roulette wheels. In another possibility, a free roulette wheel could be provided that will e.g. automatically repeat a player's roulette bet options on a main wheel.

The present invention may be applied to any suitable type of gaming apparatus or system. It can apply to stand-alone gaming apparatus, e.g. electronic gaming machines, such as video gaming machines, to gaming machines that are linked together, e.g. via a network such as an intranet, and/or to gaming systems provided through computing or other electronic devices, e.g. personal computers, PDAs, mobile telephones, digital television, and the like, e.g. over the Internet or other communications networks.

In networked games, the apparatus may include a central control for conducting games and managing the accounting and the like, and a number of remote terminals/clients that provide user input and display mechanisms.

The present invention extends to central controls/servers and to remote terminals/clients that are configured to carry out the roulette gaming of the present invention.

Viewed from another aspect, the present invention provides a gaming system including:

a plurality of roulette wheels;

input means for allowing a user to place a bet or bets on the plurality of roulette wheels during a betting round;

means for determining the win statuses of the plurality of roulette wheels after they are spun; and

means for displaying the result of a bet based on the input bet or bets and on the win statuses of the roulette wheels.

### SUMMARY OF THE INVENTION

Viewed from another aspect, the present invention provides a method of operating a gaming machine, the method including the steps of:

obtaining a bet or bets from a user;

placing the bet or bets on a plurality of roulette wheels in a single betting round;

spinning the plurality of roulette wheels;

determining the statuses of the plurality of roulette wheels after they are spun; and

displaying the betting results based on the input bet or bets and on the statuses of the roulette wheels.

Viewed from a further aspect, the present invention provides gaming software including:

a component for obtaining a bet or bets from a user;

a component for placing the bet or bets over a plurality of roulette wheels in a single betting round;

a component for determining the statuses of the plurality of roulette wheels after they are spun; and

a component for displaying the betting results based on the input bet or bets and on the statuses of the roulette wheels.

The present invention also extends to computer software products including a data storage medium on which gaming software according to the present invention is stored.

Viewed from a still further aspect, the present invention provides electronic gaming apparatus including:

means for generating a plurality of virtual roulette wheels;

means for receiving a bet or bets from a user in relation to the plurality of virtual roulette wheels;

means for spinning the roulette wheels; and

means for determining a user's winnings based on the results of the wheel spins and on the user bet or bets.

Preferably, the apparatus includes automatic bet allocation means for automatically placing a separate bet on each of the virtual wheels based on a user bet.

Viewed from another aspect, the present invention provides a roulette game playing system, including:

a plurality of physical roulette wheels; and

a betting terminal;

wherein the betting terminal allows a player to bet on the plurality of roulette wheels at the same time.

The bets may be placed on the plurality of roulette wheels automatically based on a bet input by a player, and/or may be placed on the plurality of roulette wheels manually by the player.

Viewed from a further aspect, the present invention provides electronic gaming apparatus including:

a plurality of roulette wheels;

means for inputting a bet, including means for generating a single electronic roulette betting board through which one or more roulette bets may be placed on the plurality of roulette wheels;

means for automatically placing bets on the plurality of roulette wheels based on an input bet or bets;

means for determining the win statuses of the plurality of roulette wheels after a spin; and

means for determining a win or wins based on the win statuses of the plurality of roulette wheels and on the bet or bets placed.

Viewed from another aspect, the present invention provides an electronic roulette game in which the game includes a plurality of roulette wheels that a user is able to bet on centrally in a single betting round. The electronic game may include a plurality of virtual wheels that a user is able to bet on, or may include an electronic betting terminal and a plurality of physical roulette tables, the terminal allowing a user to bet centrally on the physical roulette tables. The electronic game may include a bet allocation means for automatically allocating bets across the roulette wheels.

Viewed from a still further aspect, the present invention provides gaming apparatus including:

a plurality of roulette wheels;

input means for allowing a user to place one or more bets on the plurality of roulette wheels;

bet allocation means for placing a separate bet on each of the roulette wheels based upon a bet input by a user;

means for determining the statuses of the plurality of roulette wheels after the wheels have been spun; and

means for displaying the bet outcome, the bet outcome being based on the input bet and on the statuses of the wheels.

The bet allocation means may repeat the user input bet across the plurality of wheels. The bet allocation means may place the user bet on one wheel, and may place different bets on the other wheels, the bets on the other wheels may be different in amount and/or type, and may vary according to a set formula.

It should be noted that any of the further aspects mentioned above may include any of the features mentioned in relation to the first aspect of the present invention.

### BRIEF DESCRIPTION OF THE DRAWINGS

Embodiments of the present invention will now be described, by way of example only, with reference to the accompanying drawings. It is to be understood that the particularity of the drawings does not supersede the generality of the preceding description of the invention.

In the drawings:

FIG. 1 is a block diagram of gaming apparatus according to an embodiment of the present invention;

FIG. 2 is a display screen shot showing a game display according to an embodiment of the present invention;

FIG. 3 is a flow diagram of a gaming control process in accordance with an embodiment of the present invention; and

FIG. 4 is a block diagram of gaming apparatus according to another embodiment of the present invention.

### DETAILED DESCRIPTION

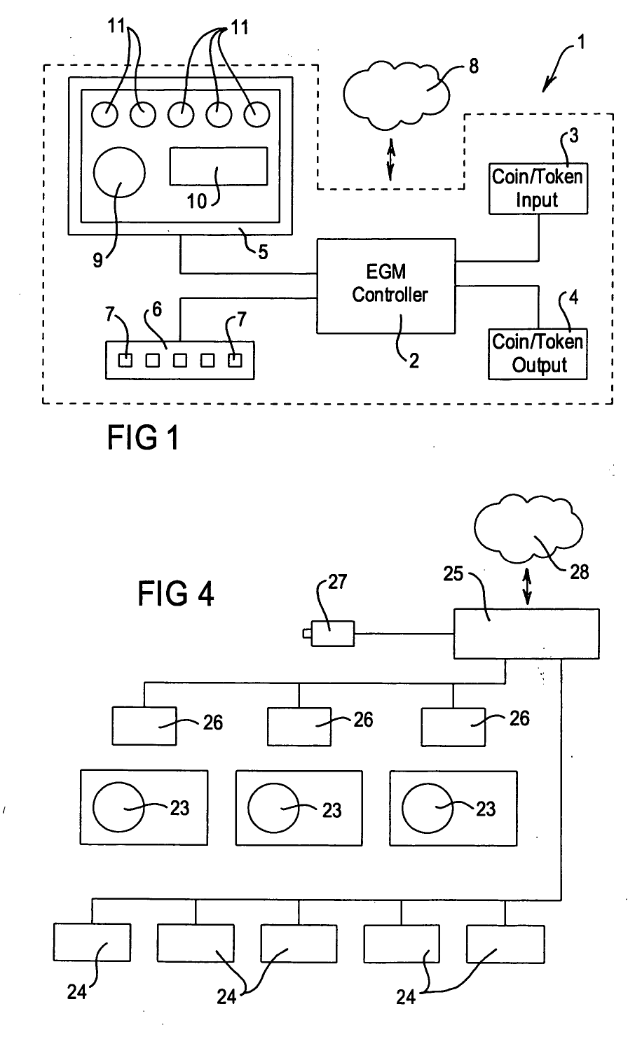

Referring to FIG. 1, gaming apparatus, which in this case takes the form of an electronic gaming machine (EGM) 1, includes various standard components, such as a controller 2 for controlling the operation of the EGM 1 and the games run on it, a coin/token/card input 3 for receiving bets, a coin/token/card output 4 for paying out winnings, a display 5 for displaying game screens, and a user input 6, including e.g. buttons 7, for allowing user interaction.

The EGM 1 may be a stand-alone machine. It may also be networked with other EGMs and/or with a control centre via a suitable communications network 8, such as a LAN and/or WAN, in order to play networked (e.g. intranet or Internet) games, such as for example a linked jackpot.

In use, the EGM 1 will display an initial gaming screen on the display 5. A player will insert coins and/or tokens into the EGM input 3, and will press a button 7 to initiate play and otherwise interact with the game. How matters then proceed will depend on the game being played.

In roulette, the EGM 1 will display a virtual roulette wheel 9 and a betting board 10. The player selects the amount to bet e.g. using the buttons 7 and selects the type of bet through the board 10. The type of bet may include any of the standard roulette bets, e.g. a single, odd/even, red/black, split, triple, corner, row, column, line, top line, dozen, hi/lo or the like.

Once a bet has been placed, the EGM 1 will determine a winning wheel slot in accordance with a stored gaming algorithm and random number generator, and will provide an animation of the screen wheel 9 and an associated roulette ball, e.g. the wheel spins and the ball comes to rest in, or is just shown in, the winning slot.

The EGM 1 then pays out any winnings in accordance with the bets laid.

In accordance with the present invention, the EGM 1 simulates and displays a number of extra roulette wheels 11 on which bets can also be placed at the same time as betting on the main wheel 9, e.g. by duplicating the bet across all of the wheels. Thus, a user is able to bet on and to play multiple roulette wheels at the same time. The user can bet on all of the wheels during a single round of betting using the same apparatus and betting board, and the wheels can be spun together, e.g. in a simultaneous or partly overlapping manner.

The ability to bet on a number of wheels in one go increases gameplay for the user. It provides for added excitement and opens the door to further enhancements, such as win events based across a number of the wheels. It also benefits the EGM owner, as gaming participation and bet rate can be increased.

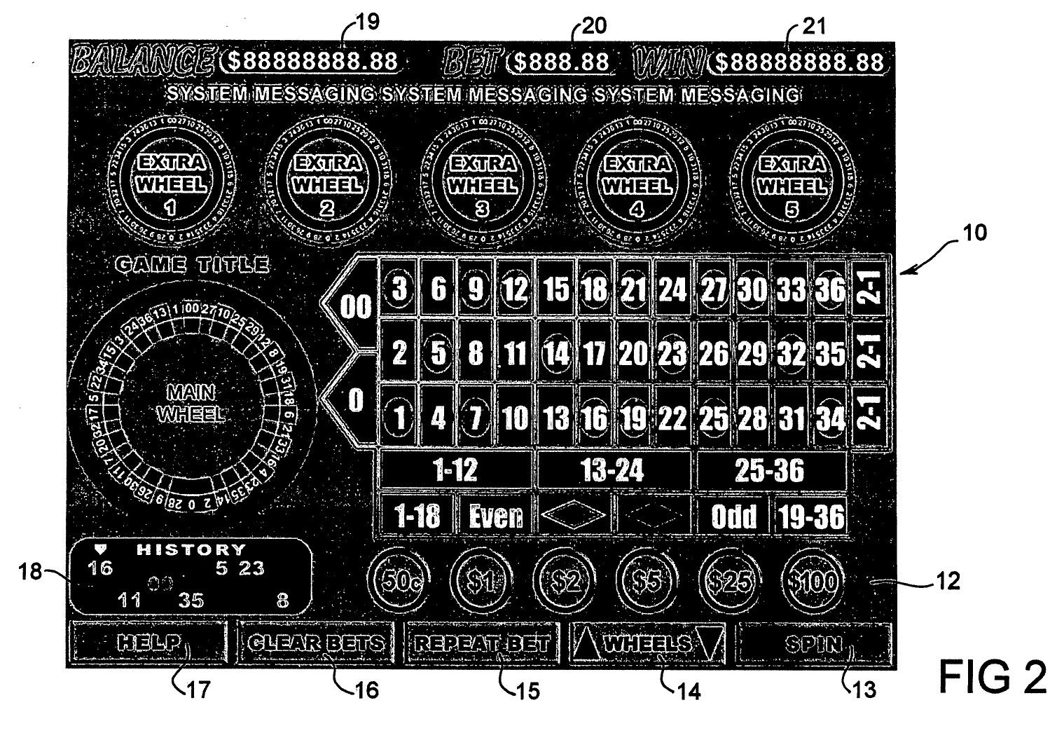

FIG. 2 is a generic screen shot showing one embodiment of how a roulette game according to the present invention may be implemented. The screen shot shows the virtual roulette wheels 9 and 11, and a standard American-style betting board 10 (other styles are possible, e.g. the Australian/Monte-Carlo style which does not have the “00”).

A user of the machine 1 selects a stake amount from their balance using screen touch buttons 12, and indicates the type of bet on the betting board 10, e.g. by touching within a specific number or box, or by touching a line or line-crossing to provide a split, corner or the like. Several bets may be placed at the same time by repeating the stake selection and board placement.

In one embodiment, a player's bets on the main wheel 9 are repeated on each of the other wheels 11, so that a bet of $2 on a single on the main wheel becomes a bet of $12 spread over all six wheels—$2 per wheel, each bet on the same single.

The player then presses the “spin” button 13 to start the wheels 9 and 11 spinning, and the EGM 1 determines the result of the spin for each wheel. The wheels 9 and 11 may all spin and stop together, or may stop successively in order to allow the player to experience the anticipation of the “ball drop” for each wheel independently. The wheels 9 and 11 could also spin in any other suitable manner relative to one another, e.g. as one stops, another may begin spinning. Overlapping spins and successive rapid ball drops may provide a particularly pleasing experience.

The “wheels” button 14 allows a player to determine the number of extra wheels to play.

Other buttons include a “repeat” button 15 for repeating the bets of a previous round, a “clear” button 16 for clearing a bet, e.g. if an error has occurred in the placement, and a “help” button 17 for obtaining instructions on how to play the game and the like.

The display includes a history window 18 for showing previous spin results. It also includes a “balance” window 19, a “bet” window 20 and a “win” window 21 to keep track of a player's bets, and a messaging line 22 for displaying messages, e.g. from a central control.

As well as repeating the main bet over all of the wheels, other bet allocation regimes are also possible. For example, bets on the extra wheels 11 may be at set values or may be set at a percentage or increment of the main bet, and may be higher or lower than the main bet.

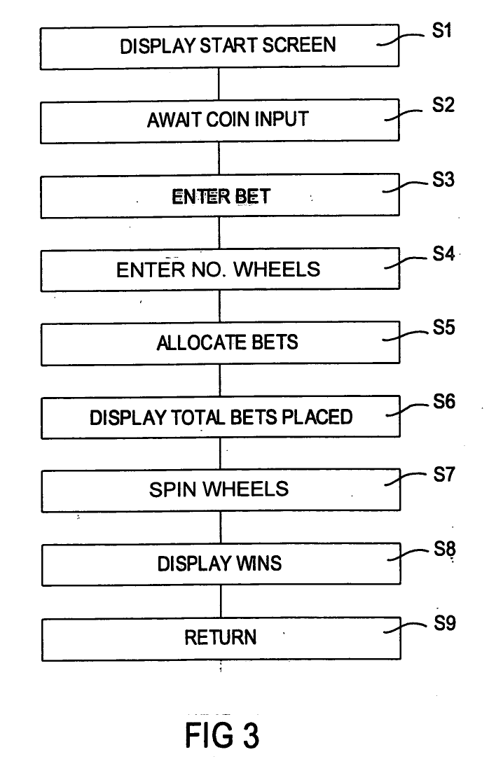

FIG. 3 shows a possible flowchart for the processing of a roulette game by the controller 2. Thus, the invention may be put into effect by the controller 2 running software that incorporates a subroutine executing in the manner shown.

At step S1, the routine displays a start screen e.g. as shown in FIG. 2. The routine awaits the input of coins, tokens, cards or the like in step S2, and when the user has deposited a sufficient balance in the machine, the EGM 1 passes to step S3, in which it prompts for the amount to be bet in the current round of play and the type of bet to be made. Prompting may occur e.g. through the flashing of the relevant buttons and the like. Thus, a user would select the bet types and amounts that they would like to place, e.g. $5 on 13, $25 on Red, and $10 on the second Dozen.

Next, the routine prompts at step S4 for the number of wheels to be played, e.g. the player selects four or five wheels or some other number using the up/down wheel button 14.

In step S5, the EGM 1 automatically allocates the bets made on the betting board to each of the wheels. This may be based on the initial bet, and e.g. each wheel may be allocated the same bet as the main bet or a percentage or increment thereof, or some other allocation regime may be used. The overall bet placed in displayed in the “Bet” window 20 at step S6. This step may be carried out each time the player increases the number of wheels in step S4, so that if a player has insufficient funds for the number of wheels to be played, then the number of wheels playable could be suitably restricted.

The allocation of bets across the wheels may be a simple repeat of the bets for each wheel. In one embodiment, the option is provided of increasing the amount of the bet for each wheel, e.g. on wheels 1 and 3 a player may play the initial input amount, whilst on wheel 2 a player may play twice the amount of the main bets (e.g. the above bet may be $10 on 13, $50 on Red and $20 on the second Dozen), and on another wheel may play another multiple of the bets. A Bet Up/Down button may be provided to facilitate this function.

The EGM 1 then waits for the “spin” button 13 to be pressed by the user, and, in response to the button's activation, in step S7, generates the winning slots for the wheels 9 and 11 and animates the wheel spins in accordance with the results. These wheel spins may overlap to a greater or lesser extent, preferably with the wheel spins ending in quick succession one after the other.

Once the spins are finished, the EGM 1 determines any winnings for the user, in step S8, and displays the combined winnings from across the roulette wheels in the “win” window 21.

The routine finishes in step S9, and the start screen is redisplayed.

The routine may of course vary from the basic form shown, and may include various validity checks, bonus games and the like, and the step order may change.

FIG. 4 is a block diagram of a second embodiment, in which the multiple wheels are provided by a plurality of real (physical) roulette wheels 23, rather than the virtual wheels of the first embodiment. The gaming apparatus includes the physical wheels 23, as well as associated electronic betting terminals 24.

In this embodiment, the wheels 23 may be provided together in close proximity to one another in a gaming pit, with a bank of the betting terminals 24 provided adjacent to them. Thus, a user can see the wheels 23 and can place bets on all of them together through one of the terminals 24, which may display a suitable screen for inputting and keeping track of bets. The screen could for example take the same form as in FIG. 2, with the displayed wheels 9 and 11 mirroring the results of the real wheel spins. Alternatively, no representation of the wheels need be made.

The gaming apparatus may also include a central control 25 for keeping track of the bets made through the terminals 24 and for informing the terminals 24 of the wheel spin results. The central control 25 may receive the spin results of the wheels 23 through croupier terminals 26, into which the croupiers who spin the wheels 23 can feed the results. Alternatively, the results could be automatically sensed, e.g. by sensors on the wheels 23 themselves.

The wheels may be human-operated, e.g. by a croupier, or could be automated. In the latter case, the wheels could for a bank of machines that are spun simultaneously or in a set sequence.

The betting on physical wheels 23 could be extended so as to cover betting on wheels in remote locations, which the user cannot observe directly, so that for example the user could bet on wheels 23 anywhere within a casino or even in another venue. Although the betting terminals 24 could just display the results of the various wheel spins, gameplay is improved if a representation of the remote wheels is provided on the terminal display.

When betting on remote wheels, or even on observable wheels, the system may provide a real-time video image of the wheels bet upon or a snap-shot of the wheel when the ball has dropped, so that the user may have confidence in the result indicated by the terminal 24. Thus, the central control may receive feed from a video camera 27 that is viewing a wheel. The camera 27 could for example be directly overhead of a wheel 23. Its output could also be used by e.g. the central control 25 to determine the winning slot number, e.g. by suitable image processing means.

The central control 25 may communicate with various other controllers, wheels, terminals and the like, e.g. via a suitable network 28, so as to provide further wheel choice and the like.

The user may be allowed to bet on a mixture of both real and virtual wheels.

In one embodiment, the user may have a choice of wheels to bet upon, and may select the wheels to play from a number of possible wheels (e.g. when playing on real wheels, a user may feel that one wheel is more favourable than another).

Physical wheels may be locked out, e.g. when all bets on the table have been placed, and a result is awaited, or when a table is dividing out winnings or where there is a dispute. In this case, a bet may still be placed on each of the remaining tables. For example, a first user bet may be placed on all possible tables in the game, one or more tables may then be locked-out for whatever reason, and a second user bet may then be placed only on the unlocked tables. Thus, in one example, one table may have two user bets on it and be just about to spin, and another table may have only one user bet on it and be in the process of spinning.

It is to be understood that various alterations, additions and/or modifications may be made to the parts previously described without departing from the ambit of the present invention, and that, in the light of the above teachings, the present invention may be implemented in software, firmware and/or hardware in a variety of manners as would be understood by the skilled person.

For example, instead of the gaming apparatus being an EGM, it may take any other suitable form, and could for example comprise a game provided on a computing or other electronic device, such as on a personal computer, PDA, mobile phone, digital television, or the like. The game may also be provided over an intranet, the Internet, or some other communications system, such as a mobile telephone system.

As well as automatic betting, it would also be possible to allow manual setting of bets across the wheels. Also, the types of bet may be varied between machines, and win events may be linked to the results of more than one wheel, e.g. a bonus win if a number of the wheels win. Various bonus and/or mystery events could be included, e.g. relating to linked jackpots, and the wheels themselves could include additional non-standard slots for e.g. bonuses or the like.

What is claimed is:

1. Gaming apparatus including:
a plurality of roulette wheels;
input means for allowing a user to place a bet or bets on the plurality of roulette wheels during a round of betting;
means for determining the win statuses of the plurality of roulette wheels after a round of spins; and
means for displaying the bet outcome, the bet outcome being based on the input bet or bets and on the win statuses of the roulette wheels.

2. The apparatus of claim 1, wherein the wheels include a virtual wheel.

3. The apparatus of claim 1, wherein the wheels include a physical wheel.

4. The apparatus of claim 3, wherein the apparatus includes means for inputting the results of the physical wheel spin.

5. The apparatus of claim 3, including electronic betting terminals that provide the input and display means.

6. The apparatus of claim 5, including a physical wheel remote from the betting terminals.

7. The apparatus of claim 3, wherein the display means displays an image or representation of the physical wheel.

8. The apparatus of claim 7, including a camera for providing an image of the physical wheel.

9. The apparatus of claim 1, including means for automatically setting the number of wheels to be bet upon in a round.

10. The apparatus of claim 1, including means for allowing a user to select the number of wheels to be bet upon in a round.

11. The apparatus of claim 1, including means for allowing a user to select the plurality of wheels from a group of possible wheels.

12. The apparatus of claim 1, wherein the apparatus includes bet allocation means for automatically placing a bet on each of the plurality of wheels based on a main bet input by the user.

13. The apparatus of claim 12, wherein the bet allocation means repeats the amount of the main bet across each of the wheels.

14. The apparatus of claim 12, wherein the bet allocation means places a bet amount on each of the wheels that is a percentage or increment of the main bet amount.

15. The apparatus of claim 12, where the bet allocation means places a bet on each of the wheels that is of the same type as that of the main bet.

16. The apparatus of claim 12, wherein the bet allocation means places a number of bets on each of the wheels based on a number of main bets.

17. The apparatus of claim 1, wherein the apparatus includes means for allowing a user to place bets manually on each of the plurality of wheels.

18. The apparatus of claim 1, wherein a win event is triggered based on the win status of any one of the wheels.

19. The apparatus of claim 1, wherein a win event is triggered based on the combined win status of two or more of the wheels.

20. The apparatus of claim 1, wherein the wheels are spun in an overlapping manner.

21. The apparatus of claim 1, wherein the wheels are spun such that they stop spinning successively.

22. The apparatus of claim 1, wherein the apparatus is an electronic gaming machine.

23. The apparatus of claim 1, wherein the apparatus includes a central control and a plurality of remote devices for receiving bets and displaying results that are in communication with the central control.

24. The apparatus of claim 1, wherein the apparatus includes a network of electronic devices.

25. A gaming system including:
a plurality of roulette wheels;
input means for allowing a user to place a bet or bets on the plurality of roulette wheels during a round of betting;
means for determining the win statuses of the plurality of roulette wheels after they are spun; and
means for displaying the bet outcome, the bet outcome being based on the input bet or bets and on the win statuses of the roulette wheels.

26. The system of claim 25, wherein the system includes a. central control for running a gaming algorithm, and a plurality of remote clients in communication with the central control over a communications network, the remote clients including means for inputting bets and displaying the results of bets.

27. A method of operating a gaming machine, the method including the steps of:
obtaining a bet or bets from a user;
placing the bet or bets on a plurality of roulette wheels in a single betting round;
spinning the plurality of roulette wheels;
determining the statuses of the plurality of roulette wheels after they are spun; and
displaying the betting results based on the input bet or bets and on the statuses of the roulette wheels.

28. Gaming software including:
a component for obtaining a bet or bets from a user;
a component for placing the bet or bets on a plurality of roulette wheels in a single betting round;
a component for determining the statuses of the plurality of roulette wheels after they are spun; and
a component for displaying the betting results based on the input bet or bets and on the statuses of the roulette wheels.

29. A computer software product including a data storage medium on which is stored computer code corresponding to software according to claim 28.

30. Electronic gaming apparatus including:
means for generating a plurality of virtual roulette wheels;
means for receiving a bet or bets from a user in relation to the plurality of virtual roulette wheels;
means for spinning the roulette wheels; and
means for determining a user's winnings based on the results of the wheel spins and on the user bet or bets.

31. The apparatus of claim 30, including automatic bet allocation means for automatically placing a separate bet on each of the virtual wheels based on a user bet.

32. A roulette game playing system, including:
a plurality of physical roulette wheels; and
a betting terminal;
wherein the betting terminal allows a player to bet on the plurality of roulette wheels at the same time.

33. The system of claim 32, wherein bets are placed on the plurality of roulette wheels automatically based on a bet input by a player.

34. The system of claim 32, wherein bets are placed on the plurality of roulette wheels manually by the player.

35. Electronic gaming apparatus including:
a plurality of roulette wheels;
means for inputting a bet, including means for generating a single electronic roulette betting board through which one or more roulette bets may be placed on the plurality of roulette wheels;
means for automatically placing bets on the plurality of roulette wheels based on an input bet or bets;
means for determining the win statuses of the plurality of roulette wheels after a spin; and
means for determining a win or wins based on the win statuses of the plurality of roulette wheels and on the bet or bets placed.

36. An electronic roulette game in which the game includes a plurality of roulette wheels that a user is able to bet on centrally in a single betting round.

37. The electronic roulette game of claim 36, wherein the game includes a plurality of virtual wheels that a user is able to bet on.

38. The electronic roulette game of claim 36, including an electronic betting terminal and a plurality of physical roulette tables, the terminal allowing a user to bet centrally on the physical roulette tables.

39. The electronic roulette game of claim 36, including a bet allocation means for automatically allocating bets across the roulette wheels.

40. Gaming apparatus including:
a plurality of roulette wheels;
input means for allowing a user to place one or more bets on the plurality of roulette wheels;
bet allocation means for placing a separate bet on each of the roulette wheels based upon a bet input by a user;
means for determining the statuses of the plurality of roulette wheels after the wheels have been spun; and
means for displaying the bet outcome, the bet outcome being based on the input bet and on the statuses of the wheels.

41. The apparatus of claim 40, wherein the bet allocation means repeats the user input bet across the plurality of wheels.

42. The apparatus of claim 40, wherein the bet allocation means places the user bet on one wheel, and places different bets on the other wheels, the bets on the other wheels being different in amount and/or type.
